(19) United States
(12) Patent Application Publication
(10) Pub. No.: US 2025/0047358 A1
(43) Pub. Date: Feb. 6, 2025

(54) QUASI CO-LOCATION CONFIGURATION FOR ENERGY HARVEST POWERED DEVICE

(71) Applicant: QUALCOMM Incorporated, San Diego, CA (US)

(72) Inventors: Min HUANG, Beijing (CN); Chao WEI, Beijing (CN); Kangqi LIU, San Diego, CA (US); Hao XU, Beijing (CN)

(21) Appl. No.: 18/697,268

(22) PCT Filed: Dec. 30, 2021
(86) PCT No.: PCT/CN2021/142982

§ 371 Date: Mar. 29, 2024

(51) Int. Cl. H04B 7/06; H04B 7/08; H04W 52/02

(52) U.S. Cl. CPC H04B 7/06968; H04B 7/088; H04W 52/0229

(57) ABSTRACT

Various aspects of the present disclosure generally relate to wireless communication. In some aspects, a user equipment (UE) may receive quasi co-location (QCL) information associated with an energy harvesting beam. The UE may perform energy harvesting, using the energy harvesting beam, based at least in part on the QCL information. Numerous other aspects are described.

### FIELD OF THE DISCLOSURE

Aspects of the present disclosure generally relate to wireless communication and to techniques and apparatuses for quasi co-location configuration for energy harvest powered device.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving quasi co-location (QCL) information associated with an energy harvesting beam. The method may include performing energy harvesting, using the energy harvesting beam, based at least in part on the QCL information.

Some aspects described herein relate to a method of wireless communication performed by a network node. The method may include transmitting, to a UE, configuration information associated with an energy harvesting capability of the UE. The method may include transmitting, to the UE, QCL information associated with an energy harvesting beam.

Some aspects described herein relate to an apparatus for wireless communication performed by a UE. The apparatus may include a memory and one or more processors, coupled to the memory. The one or more processors may be configured to receive QCL information associated with an energy harvesting beam. The one or more processors may be configured to perform energy harvesting, using the energy harvesting beam, based at least in part on the QCL information.

Some aspects described herein relate to an apparatus for wireless communication performed by a network node. The apparatus may include a memory and one or more processors, coupled to the memory. The one or more processors may be configured to transmit, to a UE, configuration information associated with an energy harvesting capability of the UE. The one or more processors may be configured to transmit, to the UE, QCL information associated with an energy harvesting beam.

Some aspects described herein relate to a non-transitory computer-readable medium that stores a set of instructions for wireless communication by a UE. The set of instructions, when executed by one or more processors of the UE, may cause the UE to receive QCL information associated with an energy harvesting beam. The set of instructions, when executed by one or more processors of the UE, may cause the UE to perform energy harvesting, using the energy harvesting beam, based at least in part on the QCL information.

Some aspects described herein relate to a non-transitory computer-readable medium that stores a set of instructions for wireless communication by a network node. The set of instructions, when executed by one or more processors of the network node, may cause the network node to transmit, to a UE, configuration information associated with an energy harvesting capability of the UE. The set of instructions, when executed by one or more processors of the network node, may cause the network node to transmit, to the UE, QCL information associated with an energy harvesting beam.

Some aspects described herein relate to an apparatus for wireless communication. The apparatus may include means for receiving QCL information associated with an energy harvesting beam. The apparatus may include means for performing energy harvesting, using the energy harvesting beam, based at least in part on the QCL information.

Some aspects described herein relate to an apparatus for wireless communication. The apparatus may include means for transmitting, to a UE, configuration information associated with an energy harvesting capability of the UE. The apparatus may include means for transmitting, to the UE. QCL information associated with an energy harvesting beam.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of channel state information reference signal beam management procedures, in accordance with the present disclosure.

FIG. 4 is a diagram illustrating an example of using beams for communications between a base station and a UE, in accordance with the present disclosure.

FIG. 5 is a diagram illustrating an example associated with a quasi co-location (QCL) configuration for an energy harvest powered device, in accordance with the present disclosure.

FIG. 6 is a diagram illustrating an example associated with a plurality of energy harvesting network nodes, in accordance with the present disclosure.

FIG. 7 is a diagram illustrating an example associated with a plurality of antennas for an energy harvesting network node, in accordance with the present disclosure.

FIG. 8 is a diagram illustrating an example process associated with a QCL configuration for an energy harvest powered device, in accordance with the present disclosure.

FIG. 9 is a diagram illustrating an example process associated with a QCL configuration for an energy harvest powered device, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

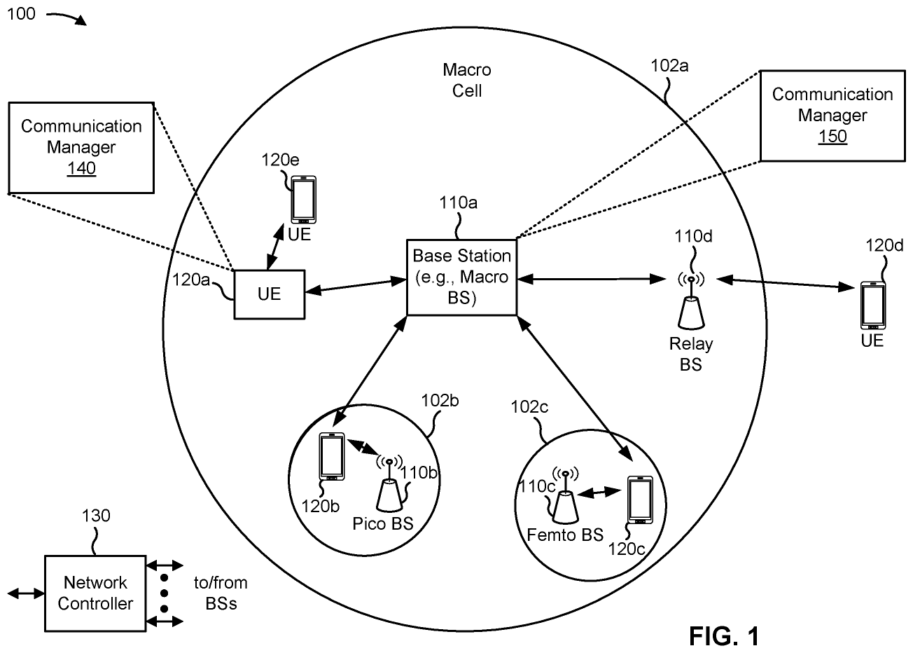

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases. NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz. FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ). FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2. FR4. FR4-a or FR4-1, and/or FR5, or may be within the EHF band. It is contemplated that the frequencies included in these operating bands (e.g., FR1, FR2, FR3, FR4, FR4-a. FR4-1, and/or FR5) may be modified, and techniques described herein are applicable to those modified frequency ranges.

In some aspects, the UE 120 may include a communication manager 140. As described in more detail elsewhere herein, the communication manager 140 may receive QCL information associated with an energy harvesting beam; and perform energy harvesting, using the energy harvesting beam, based at least in part on the QCL information. Additionally, or alternatively, the communication manager 140 may perform one or more other operations described herein.

In some aspects, the network node may include a communication manager 150. In some aspects, the network node may be a base station, such as the base station 110, and the communication manager 150 may be implemented in the base station 110. In some aspects, the network node may be an energy harvesting network node, such as the energy harvesting network node 510, and the communication manager 150 may be implemented in the energy harvesting network node 510. As described in more detail elsewhere herein, the communication manager 150 may transmit, to a UE, configuration information associated with an energy harvesting capability of the UE; and transmit, to the UE, QCL information associated with an energy harvesting beam. Additionally, or alternatively, the communication manager 150 may perform one or more other operations described herein.

As indicated above. FIG. 1 is provided as an example. Other examples may differ from what is described with regard to FIG. 1.

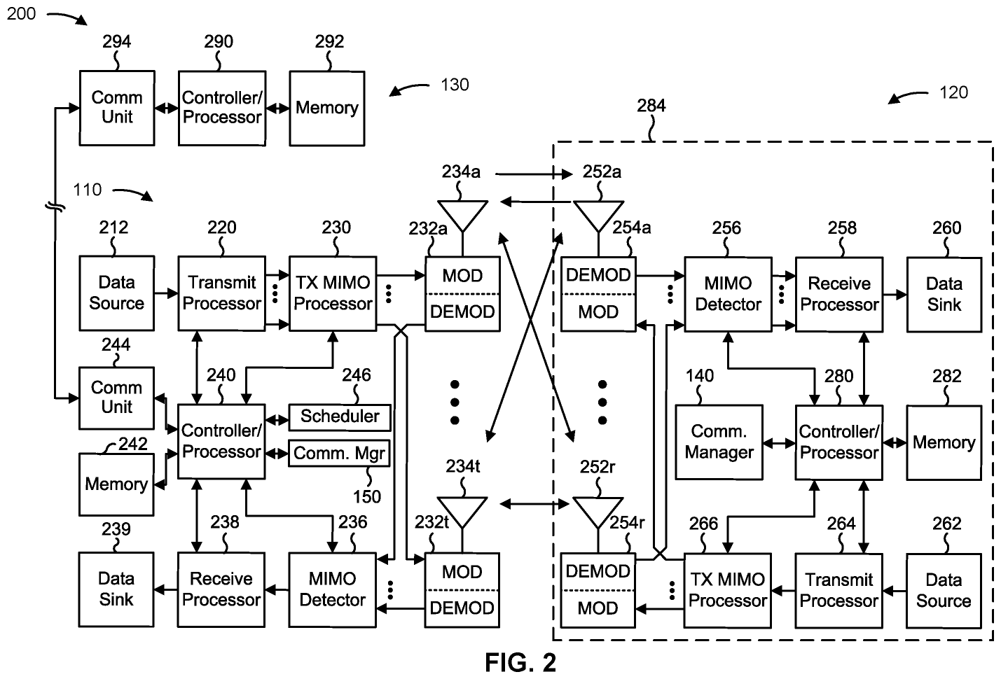

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

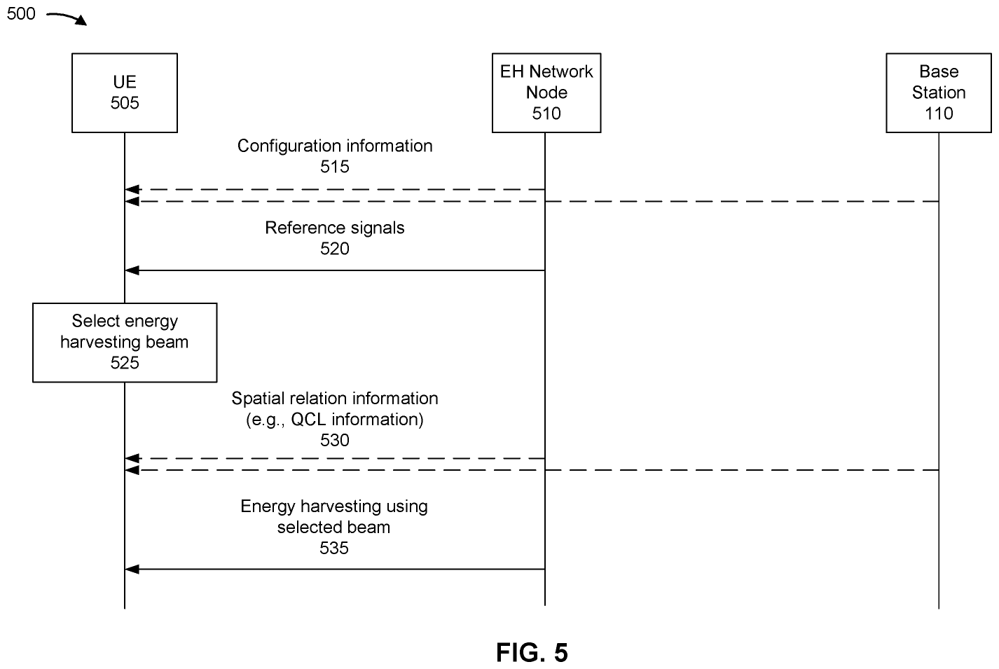

On the uplink, at the UE 120, a transmit processor 264 may receive and process data from a data source 262 and control information (e.g., for reports that include RSRP. RSSI. RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

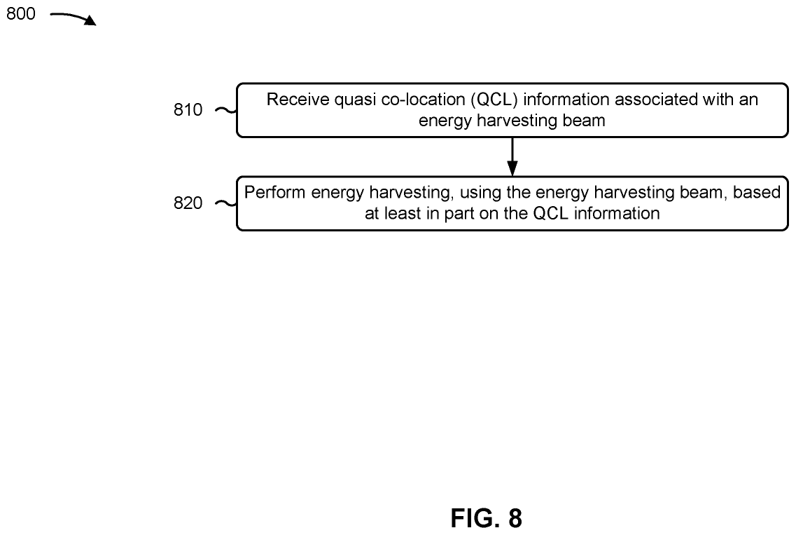

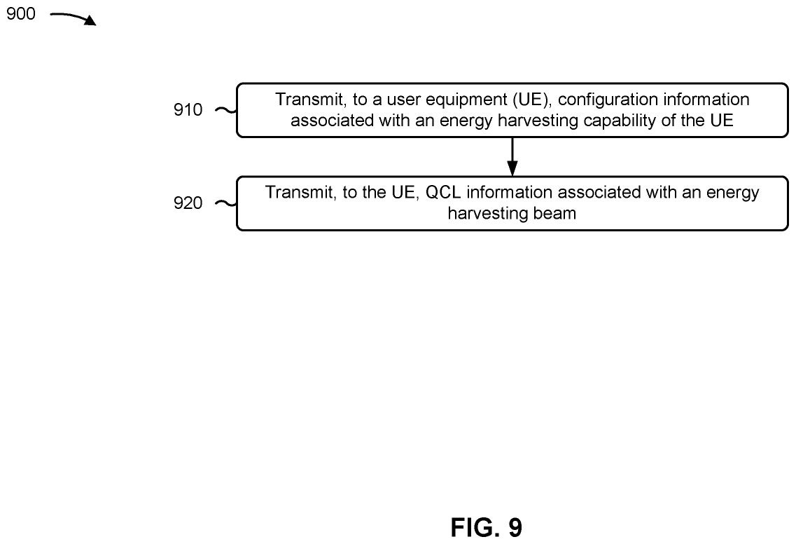

The controller/processor 240 of the base station 110, the controller/processor 280 of the UE 120, and/or any other component(s) of FIG. 2 may perform one or more techniques associated with a QCL configuration for an energy harvest powered device, as described in more detail elsewhere herein. In some aspects, a network node described herein is the base station 110, is included in the base station 110, or includes one or more components of the base station 110 shown in FIG. 2. In some aspects, a network node described herein is the energy harvesting network node 510 (described below with respect to FIG. 5), is included in the energy harvesting network node 510, or includes one or more components of the energy harvesting network node 510 (described in detail below). For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving QCL information associated with an energy harvesting beam; and/or means for performing energy harvesting, using the energy harvesting beam, based at least in part on the QCL information. The means for the UE 120 to perform operations described herein may include, for example, one or more of communication manager 140, antenna 252, modem 254. MIMO detector 256, receive processor 258, transmit processor 264. TX MIMO processor 266, controller/processor 280, or memory 282.

In some aspects, a network node includes means for transmitting, to a UE (e.g., the UE 120), configuration information associated with an energy harvesting capability of the UE; and/or means for transmitting, to the UE. QCL information associated with an energy harvesting beam. In some aspects, the means for the network node to perform operations described herein may include, for example, one or more of communication manager 150, transmit processor 220. TX MIMO processor 230, modem 232, antenna 234. MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above. FIG. 2 is provided as an example. Other examples may differ from what is described with regard to FIG. 2.

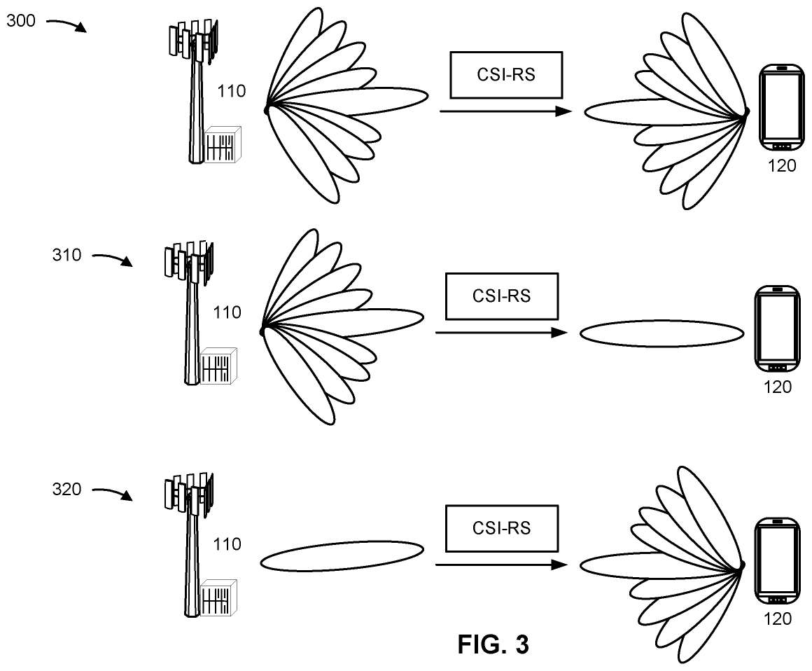

FIG. 3 is a diagram illustrating examples 300, 310, and 320 of channel state information (CSI) reference signal (RS) beam management procedures, in accordance with the present disclosure. As shown in FIG. 3, examples 300, 310, and 320 include a UE 120 in communication with a base station 110 in a wireless network (e.g., wireless network 100). However, the devices shown in FIG. 3 are provided as examples, and the wireless network may support communication and beam management between other devices (e.g., between a UE 120 and a base station 110 or transmit receive point (TRP), between a mobile termination node and a control node, between an integrated access and backhaul (IAB) child node and an IAB parent node, and/or between a scheduled node and a scheduling node). In some aspects, the UE 120 and the base station 110 may be in a connected state (e.g., a radio resource control (RRC) connected state).

As shown in FIG. 3, example 300 may include a base station 110 and a UE 120 communicating to perform beam management using CSI-RSs. Example 300 depicts a first beam management procedure (e.g. P1 CSI-RS beam management). The first beam management procedure may be referred to as a beam selection procedure, an initial beam acquisition procedure, a beam sweeping procedure, a cell search procedure, and/or a beam search procedure. As shown in FIG. 3 and example 300. CSI-RSs may be configured to be transmitted from the base station 110 to the UE 120. The CSI-RSs may be configured to be periodic (e.g., using RRC signaling), semi-persistent (e.g., using media access control (MAC) signaling), and/or aperiodic (e.g., using downlink control information (DCI)).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 300 has been described in connection with CSI-RSs, the first beam management process may also use synchronization signal blocks (SSBs) for beam management in a similar manner as described above.

As shown in FIG. 3, example 310 may include a base station 110 and a UE 120 communicating to perform beam management using CSI-RSs. Example 310 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 3 and example 310. CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 3, example 320 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 3 and example 320, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

As indicated above, FIG. 3 is provided as an example of beam management procedures. Other examples of beam management procedures may differ from what is described with respect to FIG. 3. For example, the UE 120 and the base station 110 may perform the third beam management procedure before performing the second beam management procedure, and/or the UE 120 and the base station 110 may perform a similar beam management procedure to select a UE transmit beam.

As described in more detail below, the base station 110 may configure the UE 120 with one or more beam management configurations for performing energy harvesting.

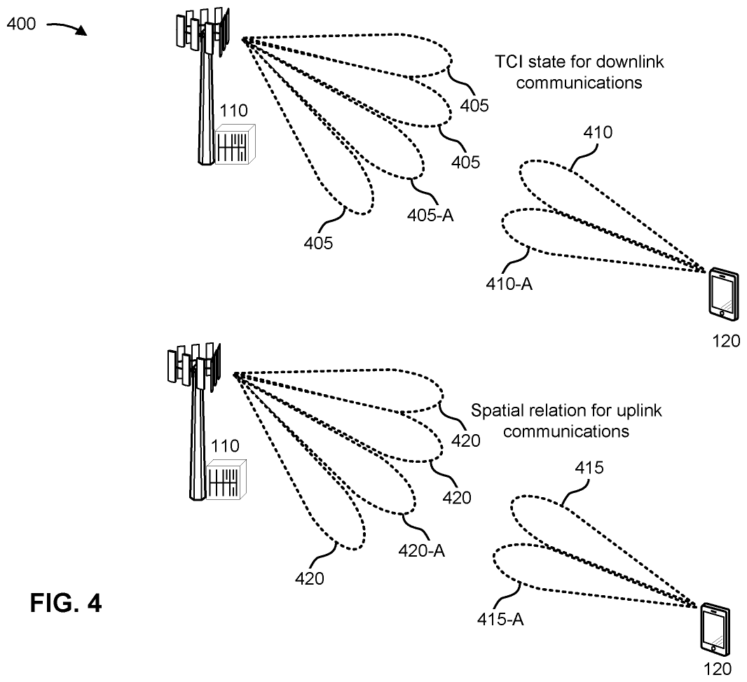

FIG. 4 is a diagram illustrating an example 400 of using beams for communications between a base station and a UE, in accordance with the present disclosure. As shown in FIG. 4, a base station, such as the base station 110, and a UE, such as the 120, may communicate with one another.

In some cases, the base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 405.

The UE 120 may attempt to receive downlink transmissions via one or more UE receive beams 410, which may be configured using different beamforming parameters at receive circuitry of the UE 120. The UE 120 may identify a particular BS transmit beam 405, shown as BS transmit beam 405-A, and a particular UE receive beam 410, shown as UE receive beam 410-A, that provide relatively favorable performance (for example, that have a best channel quality of the different measured combinations of BS transmit beams 405 and UE receive beams 410). In some examples, the UE 120 may transmit an indication of which BS transmit beam 405 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 405-A and the UE receive beam 410-A), which may be further refined and maintained in accordance with one or more established beam refinement procedures.

A downlink beam, such as a BS transmit beam 405 or a UE receive beam 410, may be associated with a transmission configuration indication (TCI) state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each BS transmit beam 405 may be associated with a SSB, and the UE 120 may indicate a preferred BS transmit beam 405 by transmitting uplink transmissions in resources of the SSB that are associated with the preferred BS transmit beam 405. A particular SSB may have an associated TCI state (for example, for an antenna port or for beamforming). The base station 110 may, in some examples, indicate a downlink BS transmit beam 405 based at least in part on antenna port QCL properties that may be indicated by the TCI state. A TCI state may be associated with a downlink reference signal set (for example, an SSB and an aperiodic, periodic, or semi-persistent CSI-RS) for different QCL types (for example, QCL types for different combinations of Doppler shift. Doppler spread, average delay, delay spread, or spatial receive parameters, among other examples). In cases where the QCL type indicates spatial receive parameters, the QCL type may correspond to analog receive beamforming parameters of a UE receive beam 410 at the UE 120. Thus, the UE 120 may select a corresponding UE receive beam 410 from a set of BPLs based at least in part on the base station 110 indicating a BS transmit beam 405 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a physical downlink shared channel (PDSCH). The set of activated TCI states for downlink control channel communications may correspond to beams that the base station 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 415.

The base station 110 may receive uplink transmissions via one or more BS receive beams 420. The base station 110 may identify a particular UE transmit beam 415, shown as UE transmit beam 415-A. and a particular BS receive beam 420, shown as BS receive beam 420-A, that provide relatively favorable performance (for example, that have a best channel quality of the different measured combinations of UE transmit beams 415 and BS receive beams 420). In some examples, the base station 110 may transmit an indication of which UE transmit beam 415 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 415-A and the BS receive beam 420-A), which may be further refined and maintained in accordance with one or more established beam refinement procedures. An uplink beam, such as a UE transmit beam 415 or a BS receive beam 420, may be associated with a spatial relation. A spatial relation may indicate a directionality or a characteristic of the uplink beam, similar to one or more QCL properties, as described above.

In some cases, the UE 120 may be configured to perform energy harvesting. In some cases, energy harvesting may include harvesting energy in an environment, or from an environment, and storing the energy (e.g., in a rechargeable battery). In some cases, the energy may be solar energy, heat energy, or radio frequency radiation energy, among other examples. In some cases, the UE 120 may be a reduced capabilities (RedCap) UE, such as a UE configured for the IoT. However, the UE 120 is not limited to being a RedCap UE, and may be any type of UE that is capable of performing energy harvesting. In some cases, the UE 120 may be configured to use low power signals for intermittently performing energy harvesting. For example, the UE 120 may use a wake-up radio (WUR) or wake-up signal (WUS) receiver (e.g., in downlink communications) for intermittently performing energy harvesting.

In some cases, the base station 110 may configure the UE 120 with different radio resources for communicating and for energy harvesting. In these cases, time division multiplexing (TDM) and/or frequency division multiplexing (FDM) may be used. Alternatively, the base station 110 may configure the UE 120 with the same resources for communicating and for energy harvesting. In this case, space division multiplexing (SDM) may be used (e.g., if the interference from the energy harvesting signal to the communication receiver can be mitigated).

In some cases, the UE 120 may use multiple antennas for communication purposes, such as for communicating with the base station 110. The base station 110 may configure the UE 120 with spatial relation information, such as QCL information, for one or more beams (e.g., communication beams) for communicating with the base station 110. For example, the spatial relation information may instruct the UE 120 to re-use a communication beam for communicating with the base station 110. In some cases, the communication beams may be used to receive control channel (e.g., PDCCH) information, data channel (e.g., PDSCH) information, or reference signal (e.g., CSI-RS) information, among other examples.

In some cases, the UE 120 may use multiple antennas for energy harvesting purposes. However, the UE 120 may not be configured with spatial relation information, such as QCL information, for the beams used for energy harvesting (e.g., energy harvesting beams). Without this spatial relation information for the energy harvesting beams, the UE 120 may not be able to use beamforming. Thus, the UE 120 may not be able to efficiently perform the energy harvesting, and may experience reduced throughput and increased latency.

Techniques and apparatuses are described herein for QCL configuration for an energy harvesting UE. In some aspects, the UE may obtain a configuration for reference receiving one or more energy harvesting signals. The UE may receive the one or more energy harvesting reference signals from an energy harvesting network node, and may select an energy harvesting beam, from a plurality of beams, for performing energy harvesting. For example, the UE may select the energy harvesting beam based at least in part on performing one or more measurements using the one or more energy harvesting reference signals. The UE may receive QCL information associated with the selected energy harvesting beam, and may perform energy harvesting (e.g., receive one or more energy harvesting signals) based at least in part on the QCL information.

As described above, a UE may be configured to use multiple energy harvesting beams for energy harvesting. However, a UE that does not have QCL information for the energy harvesting beams may not be able to efficiently receive energy harvesting signals, and may experience reduced throughput and increased latency. Using the techniques and apparatuses herein, the UE may receive QCL information for the energy harvesting beams, and may perform energy harvesting based at least in part on the QCL information. Thus, the UE may be able to efficiently receive energy harvesting signals, and may experience increased throughput, reduced latency, and a decreased charging time, or a higher charging result, for a given energy amount.

As indicated above. FIG. 4 is provided as an example. Other examples may differ from what is described with respect to FIG. 4.

FIG. 5 is a diagram illustrating an example 500 of QCL configuration for an energy harvesting UE, in accordance with the present disclosure. A UE, such as the UE 505, may communicate with a base station, such as the base station 110, and with an energy harvesting network node, such as the energy harvesting network node 510. The UE 505 may include some or all of the features of the UE 120. For example, the UE 505 may be any UE that is capable of performing energy harvesting, such as a RedCap UE or an IoT UE. In some aspects, as described in more detail below, the energy harvesting network node 510 and the base station 110 may be the same network node. For example, a communication functionality of the base station 110, and an energy harvesting functionality of the energy harvesting network node 510, may be combined in a single network node (e.g., a combined network node). The UE 505 may be configured to perform communications, and receive energy harvesting signals, from the combined network node.

As shown in connection with reference number 515, the UE 505 may receive configuration information. In some aspects, the UE 505 may receive the configuration information from the base station 110. Additionally, or alternatively, the UE 505 may receive the configuration information from the energy harvesting network node 510. In some aspects, the configuration information may indicate for the UE 505 to use one or more antennas for receiving reference signals (e.g., energy harvesting reference signals). In some aspects, the configuration information may indicate for the UE 505 to use one or more energy harvesting antennas to receive the reference signals. For example, the configuration information may indicate for the UE 505 to use an energy harvesting antenna panel to perform a beam sweeping operation for detecting and receiving reference signals from the energy harvesting network node 510.

As shown in connection with reference number 520, the energy harvesting network node 510 may transmit, and the UE 505 may receive, one or more reference signals. In some aspects, the reference signals may be energy harvesting specific reference signals (e.g., EH-RS). In some aspects, the reference signals may be communication based reference signals (e.g., CSI-RS)

As shown in connection with reference number 525, the UE 505 may select a beam (e.g., an energy harvesting beam) for performing energy harvesting. In some aspects, the UE 505 may receive the one or more reference signals using the energy harvesting antenna(s) or the energy harvesting antenna panel. For example, the UE 505 may perform a beam sweeping operation, using the energy harvesting antenna(s) or the energy harvesting antenna panel, to detect the one or more reference signals. The UE 505 may select the energy harvesting beam, from a plurality of beams, based at least in part on the one or more reference signals. In some aspects, the UE 505 may perform one or more measurements, using the one or more reference signals, and may select the energy harvesting beam, from the plurality of beams, based at least in part on the one or more measurements. For example, the UE 505 may select the beam that is directed to (e.g., pointing toward) the energy harvesting network node 510. In some aspects, the UE 505 may select the beam with the highest energy harvesting efficiency, such as the beam, of the plurality of beams, that will result in the largest beamforming channel gain. In some aspects, the UE 505 may select the beam, of the plurality of beams, with the lowest interference to the simultaneous information transmission with the communication node.

As shown in connection with reference number 530, the UE 505 may receive spatial relation information associated with the selected energy harvesting beam. In some aspects, the spatial relation information may be QCL information, or may include QCL information. The QCL information may include channel information for one or more base stations, such as the base station 110, and/or channel information for one or more energy harvesting network nodes, such as the energy harvesting network node 510. As described above, the QCL information may include delay information, such as average delay information or delay spread information, spatial receive parameter information, or Doppler information, such as Doppler shift information or Doppler spread information, among other examples. In some aspects, the QCL information may have the same format as the spatial receive parameter. For example, the QCL information may have a QCL type D format. In some aspects, the spatial relation information may include other information (e.g., non-QCL information) instead of the QCL information, or in addition to the QCL information.

In some aspects, the QCL information may be associated with an energy harvesting radio resource. For example, the QCL information may be associated with a physical energy harvesting channel (PEHCH). In some aspects, the QCL information may be associated with a communication radio resource, such as a CSI-RS, a physical broadcast channel (PBCH), a synchronization signal, or a synchronization signal and PBCH block (SSB).

In some aspects, the UE 505 may be configured with one or more QCL information types. For example, the UE 505 may be configured with a first QCL information type for performing communications (e.g., with the base station 110), and a second QCL information type for performing energy harvesting. In some aspects, the UE 505 may be configured with QCL information that can be used for performing both communications and energy harvesting.

In some aspects, the UE 505 may receive a signaling message that includes information for configuring the radio resources of the UE 505. For example, the signaling message may include information for configuring the radio resources of the UE 505 to perform energy harvesting. In some aspects, the signaling message for configuring the radio resources may include the QCL information. In some aspects, the signaling message for configuring the radio resources may be sent in a first communication, and the QCL information may be sent in a second communication. The signaling message for configuring the radio resources may be received from the base station 110 and/or the energy harvesting network node 510.

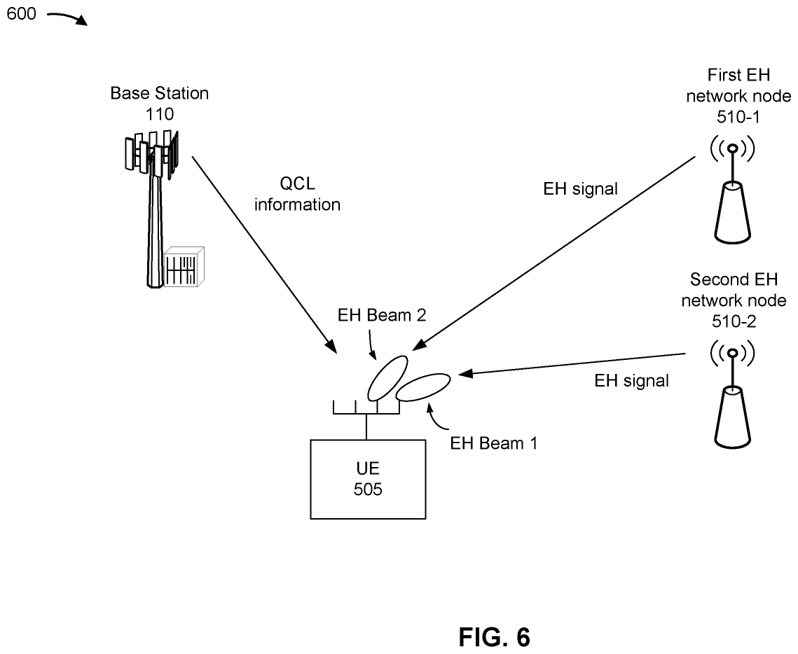

In some aspects, the UE 505 may receive QCL information associated with a plurality of energy harvesting network nodes 510. Additional details regarding this feature are described in connection with FIG. 6.

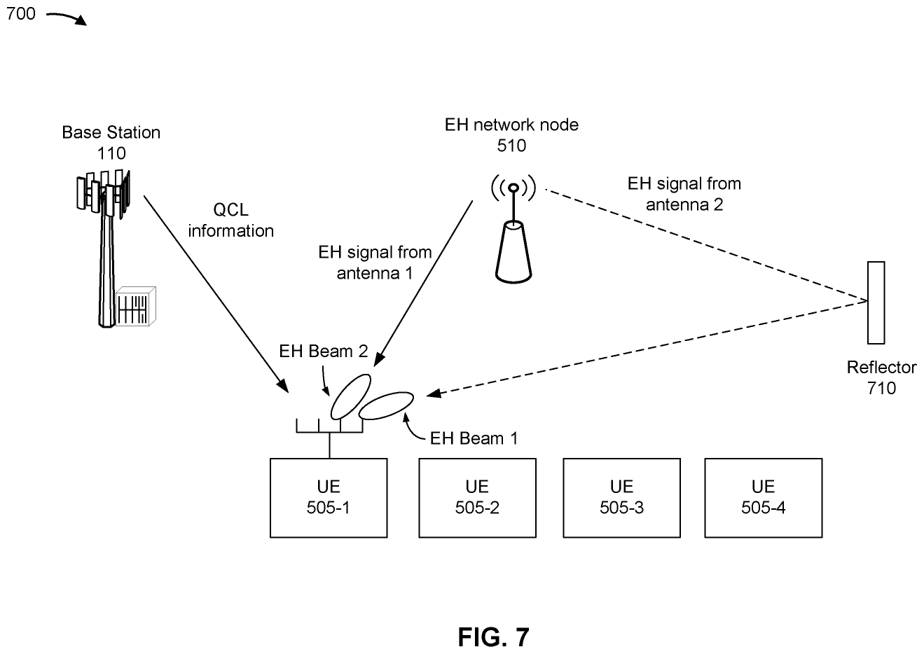

In some aspects, the UE 505 may receive QCL information associated with a plurality of antennas of the energy harvesting network node 510. Additional details regarding this feature are described in connection with FIG. 7.

In some aspects, the QCL information may be received via an RRC message, a medium access control (MAC) message (e.g., a MAC control element), or a physical layer message (e.g., DCI, uplink control information (UCI), or sidelink control information (SCI)), among other examples.

In some aspects, the QCL information may be included in a WUS. For example, if the WUS is used to activate the UE 505, the QCL information may be carried in the WUS so that the UE 505 may begin energy harvesting immediately (e.g., upon activation of the UE 505). In this example, the UE 505 may receive an energy harvesting configuration (e.g., as indicated by reference number 515), receive one or more energy harvesting reference signals (e.g., as indicated by reference number 520), and determine (e.g., select) an energy harvesting beam for energy harvesting (e.g., as indicated by reference number 525). After determining the energy harvesting beam, the UE 505 may enter a sleep mode (e.g., a sleep status). For example, the UE 505 may enter a sleep state of a discontinuous reception (DRX) cycle. Subsequently, the UE 505 may receive the WUS that includes the QCL information. The UE 505 may enter a wake state (e.g., of the DRX cycle), based at least in part on receiving the WUS, and may receive energy harvesting signals from the energy harvesting network node 510 (e.g., as indicated by reference number 530). In some aspects, if the WUS is sent via DCI, the QCL information may be included in an information field of the DCI. In some aspects, if the WUS includes a set of sequences, the QCL information may be included in a dedicated sequence.

As shown in connection with reference number 535, the UE 505 may perform energy harvesting. The UE 505 may perform the energy harvesting using the energy harvesting beam (e.g., the selected energy harvesting beam). For example, the energy harvesting network node 510 may transmit, and the UE 505 may receive, an energy harvesting signal using the energy harvesting beam. In some aspects, the energy harvesting signal may be used to provide energy to the UE 505, such as to charge a battery of the UE 505 or to provide electric capacity to the UE 505.

In some aspects, the network node 510 may transmit the energy harvesting signal via a continuous wave signal. In some aspects, the network node 510 may transmit the energy harvesting signal via an OFDM wave signal. In some aspects, if the network node 510 has multiple transmitting antennas, the network node 510 may apply a similar (e.g., the same) weight to the beams for the energy harvesting signal as the network node 510 (or the UE 120) applied to the beams for transmitting the reference signal(s). In some aspects, the energy harvesting signal may be a single carrier wave or an SC-FDMA wave. In some aspects, the spatial relation information may be related to a recent (e.g., the previous) configured reference signal for the energy harvesting measurement. For example, the QCL for the energy harvesting signal may use the same spatial receive parameter as the reference signal that was used in the previous measurement.

As described above, the UE 505 may receive (and transmit) communication signals from the base station 110, and may receive energy harvesting signals from the energy harvesting network node 510. In some aspects, the base station 110 and the energy harvesting network node 510 may be separate devices. In some aspects, some or all of the functionalities of the base station 110 (e.g., the communication functionalities), and some or all of the functionalities of the energy harvesting network node 510 (e.g., the energy harvesting functionalities) may be combined into a single device (e.g., a combined network node). For example, the combined network node may be configured to provide the UE 505 with the energy harvesting configuration information (as indicated by reference number 515), transmit the one or more reference signals (as indicated by reference number 520), transmit the QCL information for the selected beam (as indicated by reference number 530), and/or transmit the energy harvesting signals (as indicated by reference number 535).

As described above, the UE 505 may be configured to use multiple energy harvesting beams for energy harvesting. However, if the UE 505 does not have QCL information for the energy harvesting beams, the UE 505 may not be able to efficiently receive energy harvesting signals, and may experience reduced throughput and increased latency. Using the techniques and apparatuses herein, the UE 505 may receive QCL information for the energy harvesting beams, and may perform energy harvesting based at least in part on the QCL information. Thus, the UE 505 may be able to efficiently receive energy harvesting signals, and may experience increased throughput, reduced latency, and a decreased charging time, or a higher charging result, for a given energy amount.

As indicated above. FIG. 5 is provided as an example. Other examples may differ from what is described with respect to FIG. 5.

FIG. 6 is a diagram illustrating an example 600 of a plurality of energy harvesting network nodes, in accordance with the present disclosure. The UE 505 may communicate with the base station 110 and a plurality of energy harvesting network nodes 510, such as a first energy harvesting network node 510-1 and a second energy harvesting network node 510-2.

In some aspects, the first energy harvesting network node 510-1 may transmit, and the UE 505 may receive, a first set of one or more reference signals. As described above in connection with the example 500 (e.g., reference number 525), the UE 505 may select a first energy harvesting beam (e.g., EH Beam 1), for performing energy harvesting, based at least on the first set of one or more reference signals. For example, the UE 505 may perform one or more measurements using the first set of one or more reference signals, and may select the first energy harvesting beam, from a plurality of beams, based at least in part on the one or more measurements.

In some aspects, the second energy harvesting network node 510-2 may transmit, and the UE 505 may receive, a second set of one or more reference signals. As described above in connection with the example 500 (e.g., reference number 525), the UE 505 may select a second energy harvesting beam (e.g., EH Beam 2), for performing energy harvesting, based at least on the second set of one or more reference signals. For example, the UE 505 may perform one or more measurements using the second set of one or more reference signals, and may select the second energy harvesting beam, from a plurality of beams, based at least in part on the one or more measurements.

In some aspects, the UE 505 may receive QCL information associated with the first energy harvesting beam and/or the second energy harvesting beam. For example, the base station 110 or the first energy harvesting network node 510-1 may transmit, and the UE 505 may receive, first QCL information associated with the first energy harvesting beam. Additionally, or alternatively, the base station 110 or the second energy harvesting network node 510-2 may transmit, and the UE 505 may receive, second QCL information associated with the second energy harvesting beam.

In some aspects, the UE 505 may be configured to perform energy harvesting based at least in part on the QCL information. For example, the UE 505 may receive one or more energy harvesting (EH) signals from the first energy harvesting network node 505-1 based at least in part on the first QCL information. Additionally, or alternatively, the UE 505 may receive one or more energy harvesting signals from the second energy harvesting network node 510-2 based at least in part on the second QCL information.

In some aspects, the first QCL information and the second QCL information may be related to the reference signal of the source energy harvesting network node. For example, the first QCL information may be related to the first set of reference signals received from the first energy harvesting network node 510-1. When the first energy harvesting network node 510-1 is being used, the base station 110 may configure the first QCL information in the UE 505 such that the UE 505 uses the proper beam (e.g., the first beam) for energy harvesting. Additionally, or alternatively, the second QCL information may be related to the second set of reference signals received from the second energy harvesting network node 510-2. When the second energy harvesting network node 510-2 is being used, the base station 110 may configure the second QCL information in the UE 505 such that the UE 505 uses the proper beam (e.g., the second beam) for energy harvesting.

As indicated above, FIG. 6 is provided as an example. Other examples may differ from what is described with respect to FIG. 6.

FIG. 7 is a diagram illustrating an example 700 of a plurality of antennas for an energy harvesting network node, in accordance with the present disclosure. One or more UEs 505, such as the UE 505-1, 505-2, 505-3, and 505-4, may communicate with the base station 110 and the energy harvesting network node 510.

In some aspects, the energy harvesting network node 510 may be equipped with a plurality of antennas, such as a first antenna (antenna 1) and a second antenna (antenna 2). For example, when there are multiple UEs that need to perform energy harvesting, the energy harvesting network node 510 may transmit different beams to cover different UEs 505 and/or different groups of the UEs 505.

In some aspects, the energy harvesting network node 510 may change energy harvesting beams when sending energy harvesting signals. The base station 110 may indicate, to one or more of the UEs 505, the QCL information associated with one or more of the energy harvesting beams. For example, the base station 110 may transmit, and one or more of the UEs 505 may receive, first QCL information associated with a first energy harvesting beam (EH Beam 1) of the first antenna, and second QCL information associated with a second energy harvesting beam (EH Beam 2) of the second antenna.

In some aspects, the energy harvesting network node 510 may transmit, and one or more of the UEs 505 may receive, a first set of one or more reference signals. As described above in connection with the example 500 (e.g., reference number 525), the UE 505-1 may select a first energy harvesting beam, for performing energy harvesting, based at least on the first set of one or more reference signals. For example, the UE 505-1 may perform one or more measurements using the first set of one or more reference signals, and may select the first energy harvesting beam, from a plurality of beams, based at least in part on the one or more measurements. Similarly, the energy harvesting network node 510 may transmit reference signals to one or more of the other UEs (e.g., 505-2, 505-2, or 505-4), and the one or more other UEs may perform beam selection based at least in part on reference signal measurements.

In some aspects, when an energy harvesting beam is used by a particular one of the UEs 505, the base station 110, or the energy harvesting network node 510, may configure the corresponding QCL information for the particular UE 505 such that the particular UE 505 uses the proper receiver beam for energy harvesting. For example, when the UE 505-1 determines to perform energy harvesting, the base station 110, or the energy harvesting network node 510, may configure the QCL information such that the UE 505-1 uses the proper beam (e.g., the first energy harvesting beam) for energy harvesting.

As shown in the example 700, the energy harvesting network node 510 may have two transmitter beams. A first transmitter beam may be used to cover a first group of UEs 505 (e.g., UE 505-1 and UE 505-2), and a second transmitter beam may be used to cover a second group of UEs 505 (e.g., UE 505-3 and UE 505-4). In some aspects, the base station 110, or the energy harvesting network node 510, may indicate the QCL information to the UE 505-1 such that the UE 505-1 uses the correct beam(s) for performing energy harvesting. In some aspects, the UE 505-1 may use the first energy harvesting beam (EH Beam 1) and the second energy harvesting beam (EH Beam 2) to perform energy harvesting. For example, even though the second energy harvesting beam is directed toward the second group of UEs 505, the UE 505-1 may receive at least a portion of the energy harvesting signals (e.g., via the reflector 710) via the second energy harvesting beam.

As indicated above. FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with QCL configuration for energy harvest powered device.

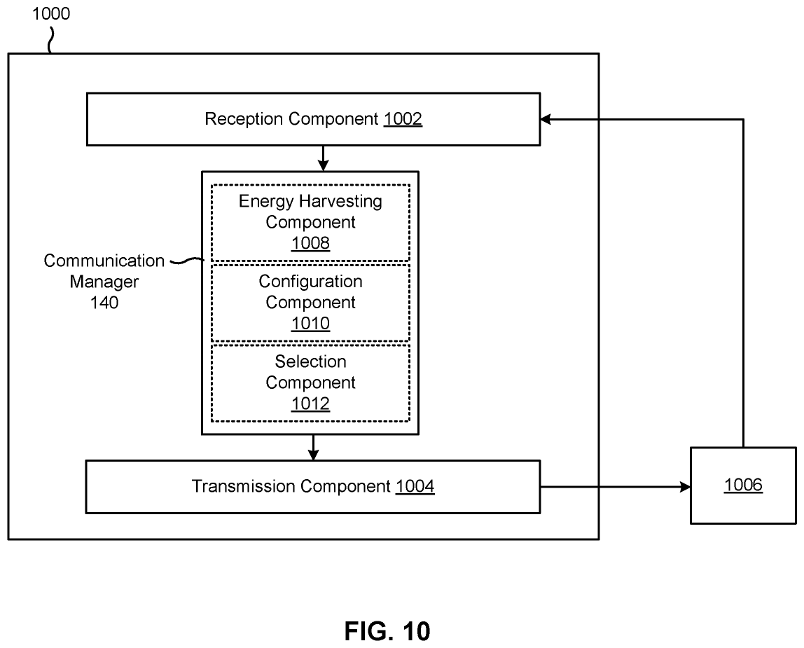

As shown in FIG. 8, in some aspects, process 800 may include receiving quasi co-location (QCL) information associated with an energy harvesting beam (block 810). For example, the UE (e.g., using communication manager 140 and/or reception component 1002, depicted in FIG. 10) may receive QCL information associated with an energy harvesting beam, as described above.

As further shown in FIG. 8, in some aspects, process 800 may include performing energy harvesting, using the energy harvesting beam, based at least in part on the QCL information (block 820). For example, the UE (e.g., using communication manager 140 and/or energy harvesting component 1008, depicted in FIG. 10) may perform energy harvesting, using the energy harvesting beam, based at least in part on the QCL information, as described above.

Process 800 may include additional aspects, such as any single aspect or any combination of aspects described below and/or in connection with one or more other processes described elsewhere herein.

In a first aspect, performing the energy harvesting comprises receiving an energy harvesting signal, from an energy harvesting network node, via the energy harvesting beam.

In a second aspect, alone or in combination with the first aspect, the QCL information associated with the energy harvesting beam includes information for selecting the energy harvesting beam, from a plurality of beams, based at least in part on a directionality of each of the plurality of beams with respect to the energy harvesting network node.

In a third aspect, alone or in combination with one or more of the first and second aspects, receiving the QCL information comprises receiving the QCL information from a base station or receiving the QCL information from the energy harvesting network node.

In a fourth aspect, alone or in combination with one or more of the first through third aspects, process 800 includes receiving other QCL information associated with an other beam for communicating with a base station.

In a fifth aspect, alone or in combination with one or more of the first through fourth aspects, process 800 includes obtaining a configuration that indicates for the UE to use a beam sweeping antenna of the UE to perform one or more beam measurements.

In a sixth aspect, alone or in combination with one or more of the first through fifth aspects, process 800 includes receiving one or more reference signals using a beam sweeping antenna of the UE, and selecting the energy harvesting beam, from a plurality of beams, based at least in part on the one or more reference signals.

In a seventh aspect, alone or in combination with one or more of the first through sixth aspects, selecting the energy harvesting beam comprises determining an energy harvesting characteristic for one or more of the plurality of beams, and selecting the energy harvesting beam, from the plurality of beams, based at least in part on the energy harvesting characteristic of the energy harvesting beam.

In an eighth aspect, alone or in combination with one or more of the first through seventh aspects, receiving the QCL information comprises receiving first QCL information for a first energy harvesting beam associated with a first energy harvesting network node, and receiving second QCL information for a second energy harvesting beam associated with a second energy harvesting network node.

In a ninth aspect, alone or in combination with one or more of the first through eighth aspects, receiving the QCL information comprises receiving first QCL information for a first energy harvesting beam associated with a first antenna of an energy harvesting network node, and receiving second QCL information for a second energy harvesting beam associated with a second antenna of the energy harvesting network node.

In a tenth aspect, alone or in combination with one or more of the first through ninth aspects, the QCL information is received via a radio resource control message, a medium access control message, downlink control information, uplink control information, or sidelink control information.

In an eleventh aspect, alone or in combination with one or more of the first through tenth aspects, the QCL information is received via a wake up signal.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node performs operations associated with QCL configuration for energy harvest powered device. In some aspects, the network node may be the base station 110. In some aspects, the network node may be the energy harvesting network node 510. In some aspects, the network node may include at least some of the features of the base station 110 and at least some of the features of the energy harvesting network node 510.

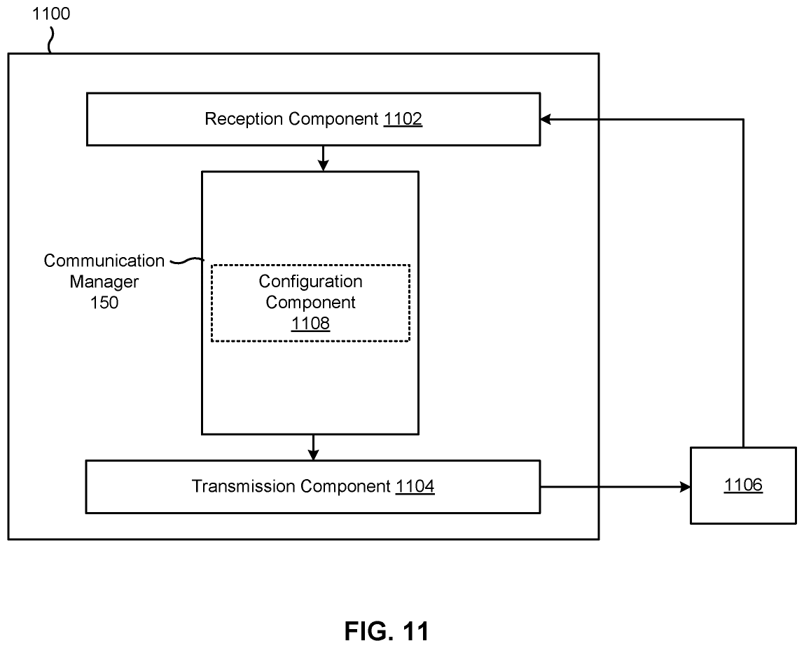

As shown in FIG. 9, in some aspects, process 900 may include transmitting, to a UE, configuration information associated with an energy harvesting capability of the UE (block 910). For example, the network node (e.g., using communication manager 150 and/or transmission component 1104, depicted in FIG. 11) may transmit, to a UE, configuration information associated with an energy harvesting capability of the UE, as described above.

As further shown in FIG. 9, in some aspects, process 900 may include transmitting, to the UE, QCL information associated with an energy harvesting beam (block 920). For example, the network node (e.g., using communication manager 150 and/or transmission component 1104, depicted in FIG. 11) may transmit, to the UE, QCL information associated with an energy harvesting beam, as described above.

Process 900 may include additional aspects, such as any single aspect or any combination of aspects described below and/or in connection with one or more other processes described elsewhere herein.

In a first aspect, the network node is a base station.

In a second aspect, alone or in combination with the first aspect, the QCL information associated with the energy harvesting beam includes information for selecting the energy harvesting beam, from a plurality of beams, based at least in part on a directionality of each of the plurality of beams with respect to an energy harvesting network node.

In a third aspect, alone or in combination with one or more of the first and second aspects, process 900 includes transmitting other QCL information associated with an other beam for communicating with the base station.

In a fourth aspect, alone or in combination with one or more of the first through third aspects, the network node is an energy harvesting network node.

In a fifth aspect, alone or in combination with one or more of the first through fourth aspects, the QCL information associated with the energy harvesting beam includes information for selecting the energy harvesting beam, from a plurality of beams, based at least in part on a directionality of each of the plurality of beams with respect to the energy harvesting network node.

In a sixth aspect, alone or in combination with one or more of the first through fifth aspects, process 900 includes transmitting, to the UE, one or more reference signals for beam selection.

In a seventh aspect, alone or in combination with one or more of the first through sixth aspects, process 900 includes transmitting, to the UE, an energy harvesting signal via the energy harvesting beam.

In an eighth aspect, alone or in combination with one or more of the first through seventh aspects, the configuration indicates for the UE to use a beam sweeping antenna of the UE to receive one or more reference signals.

In a ninth aspect, alone or in combination with one or more of the first through eighth aspects, process 900 includes receiving an indication that the UE has selected the energy harvesting beam, from a plurality of beams, based at least in part on the one or more reference signals.

In a tenth aspect, alone or in combination with one or more of the first through ninth aspects, transmitting the QCL information comprises transmitting a radio resource control message, a medium access control message, downlink control information, uplink control information, or sidelink control information, that includes the QCL information.

In an eleventh aspect, alone or in combination with one or more of the first through tenth aspects, transmitting the QCL information comprises transmitting a wake up signal that includes the QCL information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of an energy harvesting component 1008, a configuration component 1010, or a selection component 1012, among other examples.

In some aspects, the apparatus 1000 may be configured to perform one or more operations described herein in connection with FIGS. 5-7. Additionally. or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally. or alternatively, one or more components shown in FIG. 10 may be implemented within one or more components described in connection with FIG. 2. Additionally. or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive QCL information associated with an energy harvesting beam. The energy harvesting component 1008 may perform energy harvesting, using the energy harvesting beam, based at least in part on the QCL information.

The reception component 1002 may receive other QCL information associated with an other beam for communicating with a base station.

The configuration component 1010 may obtain a configuration that indicates for the UE to use a beam sweeping antenna of the UE to perform one or more beam measurements.

The reception component 1002 may receive one or more reference signals using a beam sweeping antenna of the UE.

The selection component 1012 may select the energy harvesting beam, from a plurality of beams, based at least in part on the one or more reference signals.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node, or a network node may include the apparatus 1100. In some aspects, the apparatus 1100 may be the base station 110, the energy harvesting network node 510, or the network node that includes at least some of the features of the base station 110 and at least some of the features of the energy harvesting network node 510. Alternatively, the base station 110, the energy harvesting network node 510, or the network node that includes at least some of the features of the base station 110 and at least some of the features of the energy harvesting network node 510, may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a configuration component 1108, among other examples.

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9, process XXXX of FIG. XX, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The configuration component 1108 may transmit, to a UE, configuration information associated with an energy harvesting capability of the UE. The transmission component 1104 may transmit, to the UE, QCL information associated with an energy harvesting beam.

The transmission component 1104 may transmit other QCL information associated with an other beam for communicating with the base station.

The transmission component 1104 may transmit, to the UE, one or more reference signals for beam selection.

The transmission component 1104 may transmit, to the UE, an energy harvesting signal via the energy harvesting beam.

The reception component 1102 may receive an indication that the UE has selected the energy harvesting beam, from a plurality of beams, based at least in part on the one or more reference signals.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving quasi co-location (QCL) information associated with an energy harvesting beam; and performing energy harvesting, using the energy harvesting beam, based at least in part on the QCL information.

Aspect 2: The method of Aspect 1, wherein performing the energy harvesting comprises receiving an energy harvesting signal, from an energy harvesting network node, via the energy harvesting beam.

Aspect 3: The method of Aspect 2, wherein the QCL information associated with the energy harvesting beam includes information for selecting the energy harvesting beam, from a plurality of beams, based at least in part on a directionality of each of the plurality of beams with respect to the energy harvesting network node.

Aspect 4: The method of Aspect 2, wherein receiving the QCL information comprises receiving the QCL information from a base station or receiving the QCL information from the energy harvesting network node.

Aspect 5: The method of any of Aspects 1-4, further comprising receiving other QCL information associated with an other beam for communicating with a base station.

Aspect 6: The method of any of Aspects 1-5, further comprising obtaining a configuration that indicates for the UE to use a beam sweeping antenna of the UE to perform one or more beam measurements.

Aspect 7: The method of any of Aspects 1-6, further comprising: receiving one or more reference signals using a beam sweeping antenna of the UE; and selecting the energy harvesting beam, from a plurality of beams, based at least in part on the one or more reference signals.

Aspect 8: The method of Aspect 7, wherein selecting the energy harvesting beam comprises determining an energy harvesting characteristic for one or more of the plurality of beams, and selecting the energy harvesting beam, from the plurality of beams, based at least in part on the energy harvesting characteristic of the energy harvesting beam.

Aspect 9: The method of any of Aspects 1-8, wherein receiving the QCL information comprises receiving first QCL information for a first energy harvesting beam associated with a first energy harvesting network node, and receiving second QCL information for a second energy harvesting beam associated with a second energy harvesting network node.

Aspect 10: The method of any of Aspects 1-9, wherein receiving the QCL information comprises receiving first QCL information for a first energy harvesting beam associated with a first antenna of an energy harvesting network node, and receiving second QCL information for a second energy harvesting beam associated with a second antenna of the energy harvesting network node.

Aspect 11: The method of any of Aspects 1-10, wherein the QCL information is received via a radio resource control message, a medium access control message, downlink control information, uplink control information, or sidelink control information.

Aspect 12: The method of any of Aspects 1-11, wherein the QCL information is received via a wake up signal.

Aspect 13: A method of wireless communication performed by a network node, comprising: transmitting, to a user equipment (UE), configuration information associated with an energy harvesting capability of the UE; and transmitting, to the UE, quasi co-location (QCL) information associated with an energy harvesting beam.

Aspect 14: The method of Aspect 13, wherein the network node is a base station.

Aspect 15: The method of Aspect 14, wherein the QCL information associated with the energy harvesting beam includes information for selecting the energy harvesting beam, from a plurality of beams, based at least in part on a directionality of each of the plurality of beams with respect to an energy harvesting network node.

Aspect 16: The method of Aspect 14, further comprising transmitting other QCL information associated with an other beam for communicating with the base station.

Aspect 17: The method of Aspect 13, wherein the network node is an energy harvesting network node.

Aspect 18: The method of Aspect 17, wherein the QCL information associated with the energy harvesting beam includes information for selecting the energy harvesting beam, from a plurality of beams, based at least in part on a directionality of each of the plurality of beams with respect to the energy harvesting network node.

Aspect 19: The method of Aspect 17, further comprising transmitting, to the UE, one or more reference signals for beam selection.

Aspect 20: The method of Aspect 17, further comprising transmitting, to the UE, an energy harvesting signal via the energy harvesting beam.

Aspect 21: The method of Aspect 13, wherein the configuration indicates for the UE to use a beam sweeping antenna of the UE to receive one or more reference signals.

Aspect 22: The method of any of Aspects 13-21, further comprising receiving an indication that the UE has selected the energy harvesting beam, from a plurality of beams, based at least in part on the one or more reference signals.

Aspect 23: The method of any of Aspects 13-21, wherein transmitting the QCL information comprises transmitting a radio resource control message, a medium access control message, downlink control information, uplink control information, or sidelink control information, that includes the QCL information.

Aspect 24: The method of any of Aspects 13-21, wherein transmitting the QCL information comprises transmitting a wake up signal that includes the QCL information.

Aspect 25: An apparatus for wireless communication at a device, comprising a processor: memory coupled with the processor; and instructions stored in the memory and executable by the processor to cause the apparatus to perform the method of one or more of Aspects 1-12.

Aspect 26: A device for wireless communication, comprising a memory and one or more processors coupled to the memory, the one or more processors configured to perform the method of one or more of Aspects 1-12.

Aspect 27: An apparatus for wireless communication, comprising at least one means for performing the method of one or more of Aspects 1-12.

Aspect 28: A non-transitory computer-readable medium storing code for wireless communication, the code comprising instructions executable by a processor to perform the method of one or more of Aspects 1-12.

Aspect 29: A non-transitory computer-readable medium storing a set of instructions for wireless communication, the set of instructions comprising one or more instructions that, when executed by one or more processors of a device, cause the device to perform the method of one or more of Aspects 1-12.

Aspect 30: An apparatus for wireless communication at a device, comprising a processor: memory coupled with the processor; and instructions stored in the memory and executable by the processor to cause the apparatus to perform the method of one or more of Aspects 13-24.

Aspect 31: A device for wireless communication, comprising a memory and one or more processors coupled to the memory, the one or more processors configured to perform the method of one or more of Aspects 13-24.

Aspect 32: An apparatus for wireless communication, comprising at least one means for performing the method of one or more of Aspects 13-24.

Aspect 33: A non-transitory computer-readable medium storing code for wireless communication, the code comprising instructions executable by a processor to perform the method of one or more of Aspects 13-24.

Aspect 34: A non-transitory computer-readable medium storing a set of instructions for wireless communication, the set of instructions comprising one or more instructions that, when executed by one or more processors of a device, cause the device to perform the method of one or more of Aspects 13-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive quasi co-location (QCL) information associated with an energy harvesting beam; and
perform energy harvesting, using the energy harvesting beam, based at least in part on the QCL information.

2. The apparatus of claim 1, wherein the one or more processors, to perform the energy harvesting, are configured to receive an energy harvesting signal, from an energy harvesting network node, via the energy harvesting beam.

3. The apparatus of claim 2, wherein the QCL information associated with the energy harvesting beam includes information for selecting the energy harvesting beam, from a plurality of beams, based at least in part on a directionality of each of the plurality of beams with respect to the energy harvesting network node.

4. The apparatus of claim 2, wherein the one or more processors, to receive the QCL information, are configured to receive the QCL information from a base station or the energy harvesting network node.

5. The apparatus of claim 1, wherein the one or more processors are further configured to receive other QCL information associated with an other beam for communicating with a base station.

6. The apparatus of claim 1, wherein the one or more processors are further configured to obtain a configuration that indicates for the UE to use a beam sweeping antenna of the UE to perform one or more beam measurements.

7. The apparatus of claim 1, wherein the one or more processors are further configured to:
receive one or more reference signals using a beam sweeping antenna of the UE; and
select the energy harvesting beam, from a plurality of beams, based at least in part on the one or more reference signals.

8. The apparatus of claim 7, wherein the one or more processors, to select the energy harvesting beam, are configured to determine an energy harvesting characteristic for one or more of the plurality of beams, and select the energy harvesting beam, from the plurality of beams, based at least in part on the energy harvesting characteristic of the energy harvesting beam.

9. The apparatus of claim 1, wherein the one or more processors, to receive the QCL information, are configured to receive first QCL information for a first energy harvesting beam associated with a first energy harvesting network node, and receive second QCL information for a second energy harvesting beam associated with a second energy harvesting network node.

10. The apparatus of claim 1, wherein the one or more processors, to receive the QCL information, are configured to receive first QCL information for a first energy harvesting beam associated with a first antenna of an energy harvesting network node, and receive second QCL information for a second energy harvesting beam associated with a second antenna of the energy harvesting network node.

11. The apparatus of claim 1, wherein the QCL information is received via a wake up signal.

12. An apparatus for wireless communication at a network node, comprising:
a memory; and
one or more processors, coupled to the memory, configured to:
transmit, to a user equipment (UE), configuration information associated with an energy harvesting capability of the UE; and
transmit, to the UE, quasi co-location (QCL) information associated with an energy harvesting beam.

13. The apparatus of claim 12, wherein the network node is a base station.

14. The apparatus of claim 13, wherein the QCL information associated with the energy harvesting beam includes information for selecting the energy harvesting beam, from a plurality of beams, based at least in part on a directionality of each of the plurality of beams with respect to an energy harvesting network node.

15. The apparatus of claim 13, wherein the one or more processors are further configured to transmit other QCL information associated with an other beam for communicating with the base station.

16. The apparatus of claim 12, wherein the network node is an energy harvesting network node.

17. The apparatus of claim 16, wherein the QCL information associated with the energy harvesting beam includes information for selecting the energy harvesting beam, from a plurality of beams, based at least in part on a directionality of each of the plurality of beams with respect to the energy harvesting network node.

18. The apparatus of claim 16, wherein the one or more processors are further configured to transmit, to the UE, one or more reference signals for beam selection.

19. The apparatus of claim 16, wherein the one or more processors are further configured to transmit, to the UE, an energy harvesting signal via the energy harvesting beam.

20. The apparatus of claim 12, wherein the configuration indicates for the UE to use a beam sweeping antenna of the UE to receive one or more reference signals.

21. The apparatus of claim 20, wherein the one or more processors are further configured to receive an indication that the UE has selected the energy harvesting beam, from a plurality of beams, based at least in part on the one or more reference signals.

22. The apparatus of claim 12, wherein the one or more processors, to transmit the QCL information, are configured to transmit a wake up signal that includes the QCL information.

23. A method of wireless communication performed by a user equipment (UE), comprising:
receiving quasi co-location (QCL) information associated with an energy harvesting beam; and
performing energy harvesting, using the energy harvesting beam, based at least in part on the QCL information.

24. The method of claim 23, wherein performing the energy harvesting comprises receiving an energy harvesting signal, from an energy harvesting network node, via the energy harvesting beam.

25. The method of claim 24, wherein the QCL information associated with the energy harvesting beam includes information for selecting the energy harvesting beam, from a plurality of beams, based at least in part on a directionality of each of the plurality of beams with respect to the energy harvesting network node.

26. The method of claim 24, wherein receiving the QCL information comprises receiving the QCL information from a base station or receiving the QCL information from the energy harvesting network node.

27. The method of claim 23, further comprising:
receiving one or more reference signals using a beam sweeping antenna of the UE; and
selecting the energy harvesting beam, from a plurality of beams, based at least in part on the one or more reference signals.

28. A method of wireless communication performed by a network node, comprising:
transmitting, to a user equipment (UE), configuration information associated with an energy harvesting capability of the UE; and
transmitting, to the UE, quasi co-location (QCL) information associated with an energy harvesting beam.

29. The method of claim 28, wherein the network node is a base station or an energy harvesting network node.

30. The method of claim 29, wherein the QCL information associated with the energy harvesting beam includes information for selecting the energy harvesting beam, from a plurality of beams, based at least in part on a directionality of each of the plurality of beams with respect to the energy harvesting network node.
